(19) United States
(12) Patent Application Publication
(10) Pub. No.: US 2007/0015555 A1
(43) Pub. Date: Jan. 18, 2007

(54) Portable external cell phone antenna

(75) Inventor: Bruce Fredric Bogner, Ventnor City, NJ (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: BRUCEMARV LLC

(21) Appl. No.: 11/523,913

(22) Filed: Sep. 20, 2006

Related U.S. Application Data
(63) Continuation-in-part of application No. 11/233,908, filed on Sep. 23, 2005.
(60) Provisional application No. 60/643,377, filed on Jan. 13, 2005.
(60) Provisional application No. 60/650,581, filed on Feb. 7, 2005.
(60) Provisional application No. 60/654,880, filed on Feb. 22, 2005.

(51) Int. Cl. H04M 1/00

(52) U.S. Cl. 455/575.7

(57) ABSTRACT

A portable, self contained, dual frequency external antenna configuration is provided for use with a phone, such as a cell phone having either an outwardly extending antenna or an internal antenna to enhance cell phone operation. The antenna configuration comprises a first antenna tuned to a first cell phone operating frequency and a second antenna tuned to a second cell phone operating frequency. A connector is provided, the connector adapted for making a connection to the cell phone and at least one transmission line connects the first and second antennas to the connector.

### CROSS-REFERENCE TO RELATED APPLICATIONS

This application is a continuation-in-part of U.S. patent application Ser. No. 11/233,908 filed Sep. 23, 2005 and entitled “Personal Portable External Cell Phone Antenna”, now abandoned. This application claims the benefit of U.S. Provisional Patent Applications Nos. 60/643,377 filed Jan. 13, 2005; 60/650,581 filed Feb. 7, 2005; and 60/654,880 filed Feb. 22, 2005, the subject matter of each of which is hereby incorporated herein by reference.

### BACKGROUND OF THE INVENTION

This invention relates to a portable, self contained device which incorporates patterns of electrically conductive lines in the configuration of one or more antennas tuned to one or more of the operating frequencies of a cell phone which, when connected to the cell phone, enhances the performance of the cell phone.

The need for reliable wireless communication essentially gave rise to two different ways of achieving this result. One such system utilized a set of low earth orbiting satellites and hand held transceivers. This system provided very highly reliable communication, but was too expensive to operate, the hand held devices were too large and expensive, and the two systems, Iridium and Globalstar filed for bankruptcy. The other system, utilizing small hand held devices that transmitted to a local antenna tower, outperformed the satellite systems in terms of size, cost and versatility. Now, only small hand held cell phones are in common use and antenna towers dot the landscape in order to provide the needed signal-to-noise ratio [S/N] for clear static free communication. The competition between the various suppliers of cell phones has resulted in cell phones becoming smaller and smaller. As size was reduced, the antenna attached to the cell phone also became smaller. To compensate for such smaller antennas, the power generated within the cell phone has been increasing. This trend has resulted in temperatures inside some cell phones becoming high enough to overheat the cell phone batteries, which have been reported exploding. There is a need to increase the Effective Radiated Power [ERP] of a small cell phone so that the RF power generated within the cell phones can be minimized and personal safety increased. The solution is to increase the effectiveness of the antenna system for the cell phone.

Presently there are many external antennas for sale for just this purpose. A visit to the web site AlternativeWireless.com shows many antennas for sale that will improve the reception of a cellular phone. Wilson Electronics is a manufacturer of many models of such antennas. Some of these antennas are described in U.S. Pat. Nos. 6,788,261, 6,486,840 and 6,317,089 assigned to Wilson Electronics, Inc. and U.S. Pat. No. 6,714,164 assigned to Nippon Antenna Kabushiki Kaisha. These antennas are not intended to be carried around. There are numerous models for mounting on a vehicle or being placed upon a metallic surface in a home or office to improve operation. One such antenna is the “Wilson Mini Dual Band Magnetic Mount Antenna”. All these antennas have one characteristic in common. They are only 1 of the antenna. They rely on being mounted on a fairly large metallic surface in order to create an image below the metallic surface, thereby creating a virtual entire antenna structure tuned to the cell phone frequencies of operation. However, there are no portable antennas being offered for sale to significantly improve the performance of the cell phone of the average user that operate without the need for such a metallic surface.

A visit to the Factory Direct Cellular web site reveals three small antennas that claim to provide some improvement in cell phone reception. One such device is called a “cellular Antenna Booster” that fits inside a cell phone case and claims to provide some improvement. The other devices shown are designed to attempt to transfer signals from inside a vehicle to the outside, thereby providing some measure of improvement. However, until now, there are no practical portable antennas that provide significant improvement in cell phone reception. Such an antenna must be easy to carry around and easy to connect to the cell phone when improved performance is desired/required.

The present invention solves this problem by incorporating one or more full ½ wave dipole antennas into a small assembly that can be attached to a cell phone so that the user has the advantage of an external antenna to enhance the operation of the cell phone without the cumbersome problem of carrying around a bulky external antenna that must be mounted on a metallic surface in order to be utilized. Without an external antenna, a cell phone increases the RF energy generated within the cell phone in order to achieve a secure link to a nearby tower. If a secure link to the tower cannot be achieved, the call is lost. Use of an external antenna increases the probability of achieving a secure link to a tower, thereby allowing the call to be completed, as well as minimizing the RF energy generated within the cell phone, thereby diminishing any health risks associated with holding a cell phone directly to one's head. The present invention is the first use of such technology to enhance cell phone performance. Several field trials utilizing an embodiment of the present invention have been conducted. Reliable reception was achieved in places where in the absence of the present invention no service was obtainable, notably in the mountains in New Hampshire, on the beach in Southern New Jersey, in the mountains north of San Francisco, and in the vehicle of a traveling salesman, who claims to have, for the first time, never lost a call while traveling.

There are several reasons why one skilled in the antenna art has not come up with an antenna configuration similar to the present invention. The existing antenna on a cell phone is obviously inadequate to provide a high gain link to a remote tower. So it was obvious that it made sense to bypass this antenna by connecting directly to the circuitry inside the phone, either via a coaxial connection provided by the manufacturer or by removing the cell phone antenna and plugging in a well-designed external antenna. Regarding the design of an external antenna, it was “obvious” that an omni-directional radiation pattern would be ideal since one does not know the direction to the nearest tower. Then there is the problem that the antenna must cover two separate frequency bands, separated by more than a 2:1 ratio. There are numerous classical methods of combining two frequency bands such as these into a single omni-directional configuration. It is complicated, but has been done for a long time. Once one has a dual frequency omni directional antenna in mind, utilizing a metallic ground plane to eliminate the need to fabricate the entire dipole structure appeared apparent, especially when it was the customer who had to supply the ground plane. Finally, there was the unknown effect of the human body on the operation of an antenna in close proximity. For these various reasons, external antennas currently for sale to the public are omni-directional and plug into the phone. The fact that each model phone requires a different type connection and that the customer must provide a metallic ground plane beneath the antenna are factors that the designers of external cell phone antennas felt they just had to live with.

A portable external cell phone antenna in accordance with the present invention includes a small dual frequency antenna and a means to make a connection to a cell phone. The antenna incorporates a number of narrow lines capable of conducting an electrical signal. The configuration of the conductive lines forms an antenna or array of antennas which is tuned to the frequency or frequencies of cell phone operation. According to a particularly advantageous aspect of the invention, a means is provided to wirelessly couple the present antenna to the existing antenna of a cell phone. In another particularly advantageous aspect of the invention, a means is provided to reduce the size of the antenna assembly to make it convenient to carry it on one's person. Use of the present invention enhances the performance of a cell phone and increases personal safety by minimizing the RF power generated within said cell phone.

Antennas tuned to the frequency of operation of a cell phone [806-894 MHz, referred to as the 850 MHz band, and 1850-1990 MHz, referred to as the 1950 MHz band, or some other frequency of operation] are incorporated in a small assembly. The assembly incorporates a means for the antennas to be connected to a cell phone. The user connects the assembly to a cell phone in order to improve the performance of the cell phone. In the preferred embodiment of the invention, the antenna couples directly to the cell phone antenna, thereby making it a more universal type connection, not depending upon the different means of making a direct connection to the various models of cell phones currently on the market. The present invention enhances signals in what is called the “quad-band” which includes the frequencies of 850, 900, 1800 and 1900 MHz.

### BRIEF SUMMARY OF THE INVENTION

Briefly stated, in one embodiment, the present invention comprises a portable, self contained, dual frequency external antenna configuration for use with a phone, such as a cell phone to enhance cell phone operation. The antenna configuration comprises a first antenna tuned to a first cell phone operating frequency and a second antenna tuned to a second cell phone operating frequency. A connector is provided, the connector being adapted for making a connection to the cell phone and at least one transmission line connects the first and second antennas to the connector.

In another embodiment the present invention comprises a portable, self contained, external antenna configuration for use with a phone, such as a cell phone to enhance cell phone operation. The antenna configuration comprises at least a first antenna tuned to a cell phone operating frequency and a connector adapted for making a connection to the cell phone. At least one transmission line connects the first antenna to the connector.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a simplified pictorial of a cell phone showing a typical cell phone external antenna;

FIG. 2 is a detailed pictorial of an 850 MHz antenna combined with a 1950 MHz antenna according to a preferred embodiment of the present invention;

FIG. 3 shows the antenna of FIG. 2 connected to a multiple loop connector coil via a two wire transmission line;

FIG. 4 shows the antenna configuration of FIG. 3 connected to a cell phone antenna in a wireless manner, according to one embodiment of the present invention;

FIG. 5 shows the antenna configuration of FIG. 3 connected to a cell phone antenna, according to one embodiment of the present invention where the antenna is configured as a printed circuit;

FIGS. 6A and 6B show the antenna configuration of FIG. 3 compressed and inserted into a container according to one embodiment of the invention;

FIG. 7 shows an alternate embodiment of the antenna configuration of FIG. 3 wherein the antenna and the coil are constructed as flat strips;

FIG. 8 shows a preferred embodiment of the antenna assembly of FIG. 7 wherein the antenna and connector coil are a printed circuit on a non-metallic material;

FIG. 9 shows the antenna configuration of FIG. 8 connected to the external antenna of a cell phone;

FIG. 10 shows the antenna configuration of FIGS. 6A and 6B connected to a cell phone in one embodiment of the invention;

FIGS. 11A and 11B show a simplified pictorial of a cell phone employing an internal cell phone antenna;

FIG. 12 shows the antenna configuration of FIG. 7 where the antenna is configured as a printed circuit;

FIGS. 13A, 13B, 13C, 13D and 13E show how the printed circuit antenna of FIG. 12 can be folded so as to fit within the extremities of the cell phone shown in FIG. 11;

FIG. 14 shows the folded antenna configuration of FIG. 13E connected to the cell phone of FIG. 11 in a wireless manner, according to one embodiment of the present invention;

FIG. 15A is a simplified pictorial showing a person holding a cell phone according to FIG. 14 to his head according to one embodiment of the present invention;

FIG. 15B is a simplified pictorial showing a person holding a cell phone according to FIG. 10 to his head according to a second embodiment of the present invention; and

FIG. 15C is a simplified pictorial showing a person holding a cell phone according to FIG. 11 combined with the configuration of FIG. 6 to his head according a third embodiment of the present invention;

### DETAILED DESCRIPTION OF THE INVENTION

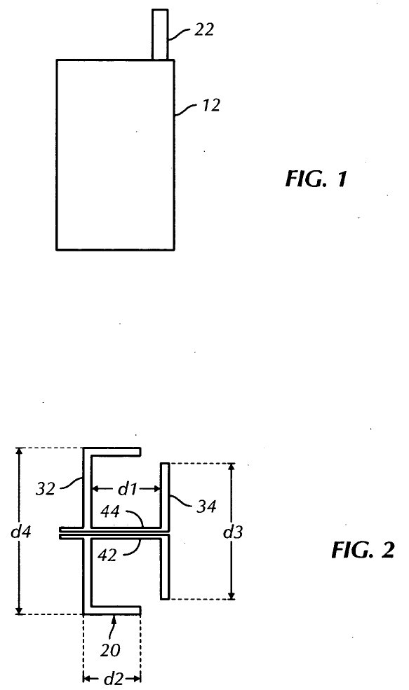

Referring to the drawings in detail, wherein like numerals indicate like elements throughout, FIG. 1 shows a typical cell phone 12 with a typical external cell phone antenna 22.

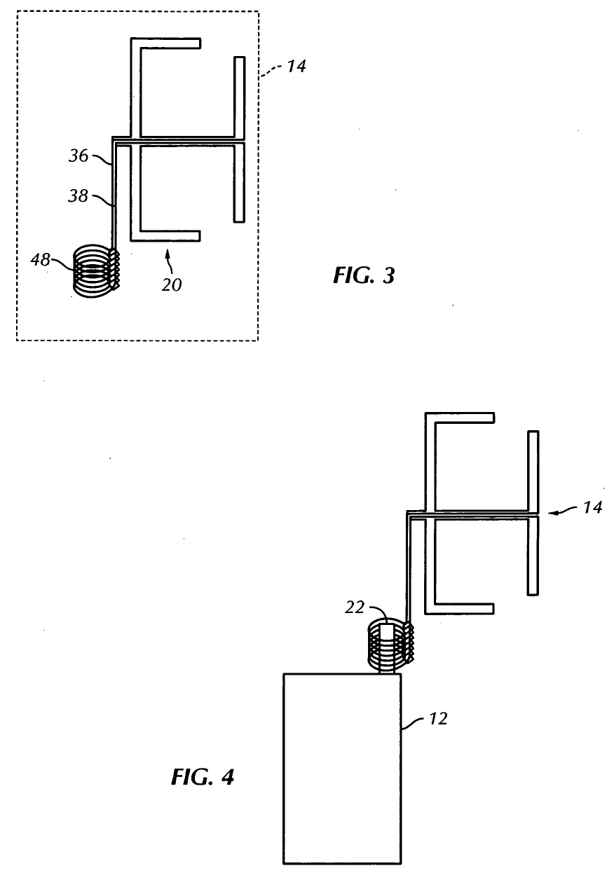

FIG. 2 shows two different antennas 32 and 34, arranged in an assembly 20 to provide greater cell phone performance enhancement than is available with a single frequency antenna. Antenna 32 is preferably tuned to the 850 MHz band and antenna 34 is preferably tuned to the 1950 MHz band. Dimensions d2, d4 and d2 when combined form a half wavelength [λ/2] in the 850 MHz band and dimension d3 is a half wavelength [λ/2] in the 1950 MHz band. Since antenna 32 and antenna 34 operate at different cell phone frequencies, there is no phase relationship between them, except that dimension d1 should preferably be as small as possible to realize the smallest possible overall size of the antenna configuration that incorporates the present invention. By setting dimension d1 at approximately λ/4 at 1950 MHz, antenna 34 utilizes antenna 32 as a reflector, thereby increasing the gain of antenna 34 in the plane of the antenna assembly. The antennae are preferably made of metallic wire but some other material such as a printed circuit may be used. Preferably, two wire transmission lines 42 and 44 connect antennas 32 and 34 to transmission lines 36, 38 (FIG. 3).

FIG. 3 shows the antenna assembly 20, connected to a multiple loop wireless connector 48 via transmission lines 36, 38. The entire antenna assembly will be hereinafter referred to as antenna configuration 14. The multiple loops of the wireless connector 48 are preferably made of insulated wire but some other material such as a printed circuit may be used. The transmission lines 36, 38 are also preferably made of wire but some other material such as a printed circuit may be used. The antenna assembly 20 may be connected to the cell phone 12 in some other manner if desired. For example, a coaxial connector (not shown) may be connected to the transmission lines 36, 38 for connection to a complementary coaxial connector (not shown) on the cell phone 12. Alternatively, the external cell phone antenna 22 could be removable and a special connector (not shown) could be used to connect the antenna assembly 20 to the cell phone 12 where the cell phone antenna 22 had been connected. Other connectors and methods of connecting the antenna assembly 20 to a cell phone 12 will be apparent to those skilled in the art.

FIG. 4 shows the antenna configuration 14 connected to cell phone 12 with the loops of the wireless connector 48 surrounding at least a portion of the cell phone external antenna 22. In this manner, the antenna configuration 14 makes a wireless connection to the cell phone antenna 22.

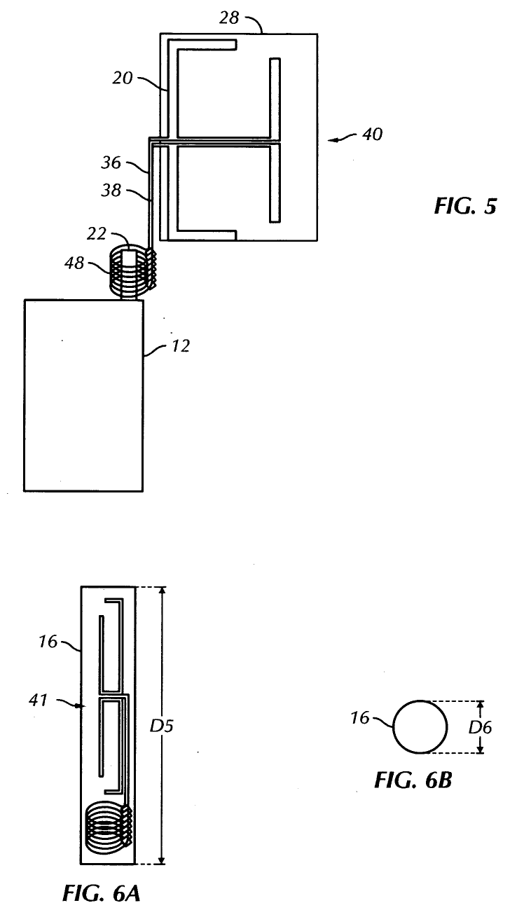

FIG. 5 shows an antenna configuration 40 according to the present invention, mounted to the external antenna 22 of cell phone 12 via the loops of the wireless connector 48 and transmission line 36, 38. Antenna configuration 40 is shown as a printed circuit 28 which incorporates the antenna configuration 20 of FIG. 3.

FIGS. 6A and 6B show one possible manner in which an external cell phone antenna in accordance with the present invention as described above can be packaged as antenna configuration 41 in a container or housing 16. The dimensions of the container 16, which in the present embodiment is generally cylindrically shaped, are shown as D5 long and D6 in diameter. Other container dimensions, shapes and configurations are within the spirit of the invention. Antenna configuration 41 is either folded, rolled or compressed in some manner in order for it to fit within the container 16. Container 16 is small and is designed such that the user can carry it on their person, so that the cell phone antenna configuration 14, according to the present invention, is readily available for use in any locality and at any time.

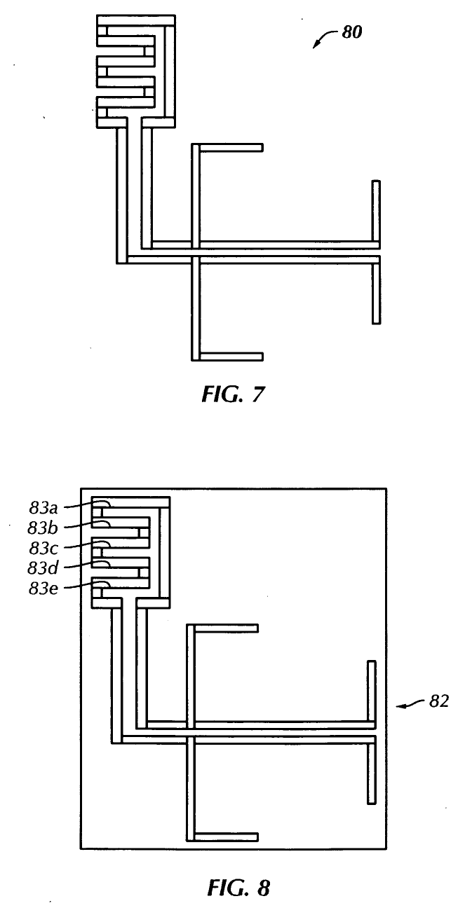

FIG. 7 shows an antenna configuration 80 as a flat strip version of the antenna configuration 14 shown in FIG. 3.

FIG. 8 shows an antenna configuration 82 fabricated as a printed circuit version of the antenna configuration 80 shown in FIG. 7. The slits 83a through 83e in the vicinity of the printed circuit coil allow the printed circuit coil to fit around an external cell phone antenna 22. There may be a different number of slits and coils than shown without violating the spirit of the invention.

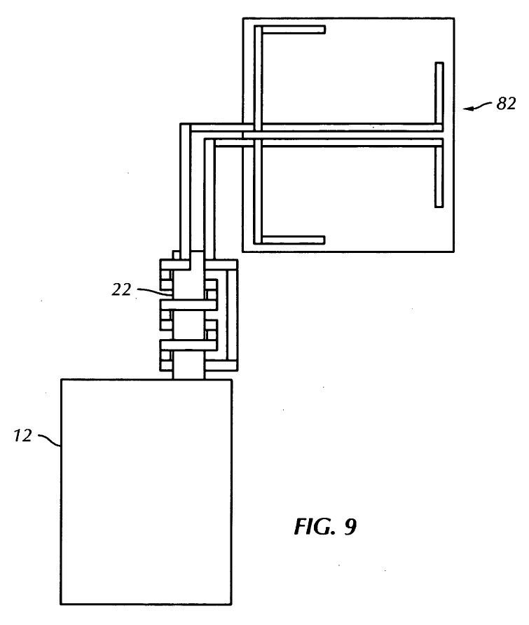

FIG. 9 shows an antenna configuration 82 as a flat strip version of the antenna configuration 14 with the printer circuit coil surrounding at least a portion of the external antenna 22 of cell phone 12 for wirelessly connecting the antenna configuration 82 to the cell phone 12 according to the present invention.

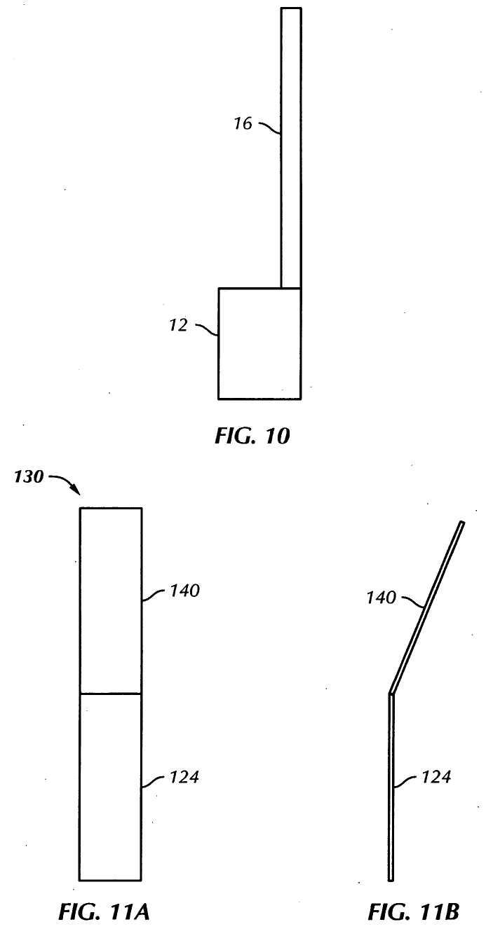

FIG. 10 shows the stored antenna configuration 41 of FIGS. 6A and 6B in the container 16 with the stored antenna configuration 41, while still in the container 16, connected to a cell phone 12 via the cell phone antenna 22, (not shown).

FIGS. 11A and 11B show of a typical flip-type cell phone 130 comprising sections 124 and 140 with a typical internal cell phone antenna (not shown) located inside of section 124 and with no external cell phone antenna. It is recognized that there are one-piece cell phones with an internal antenna. All references to a flip-type cell phone applies equally to such one-piece cell phones.

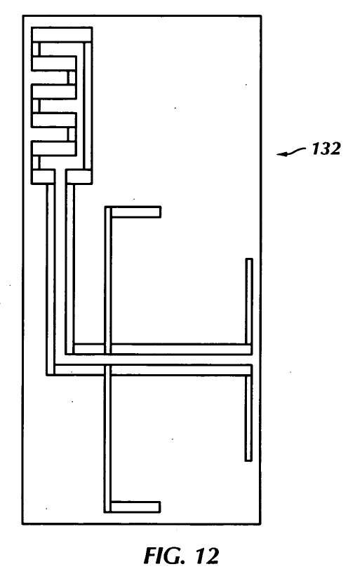

FIG. 12 shows an antenna configuration 132 which is similar to configuration 82 and has been fabricated as a printed circuit version of the antenna configuration 80 shown in FIG. 7. The slits 83a through 83e shown in FIG. 8 are not needed in this version of the printed circuit coil. There may be a different number of coils than shown without violating the spirit of the invention.

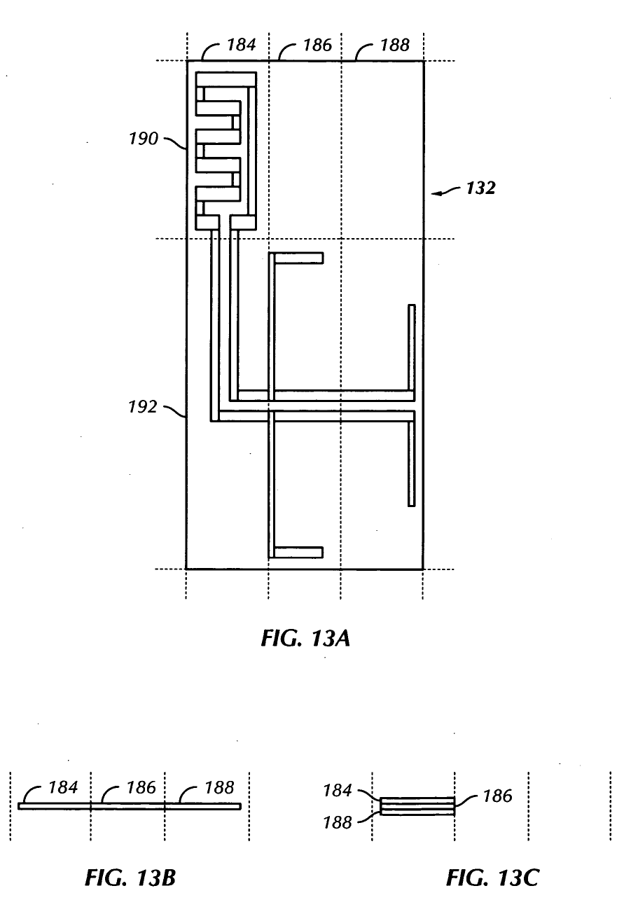

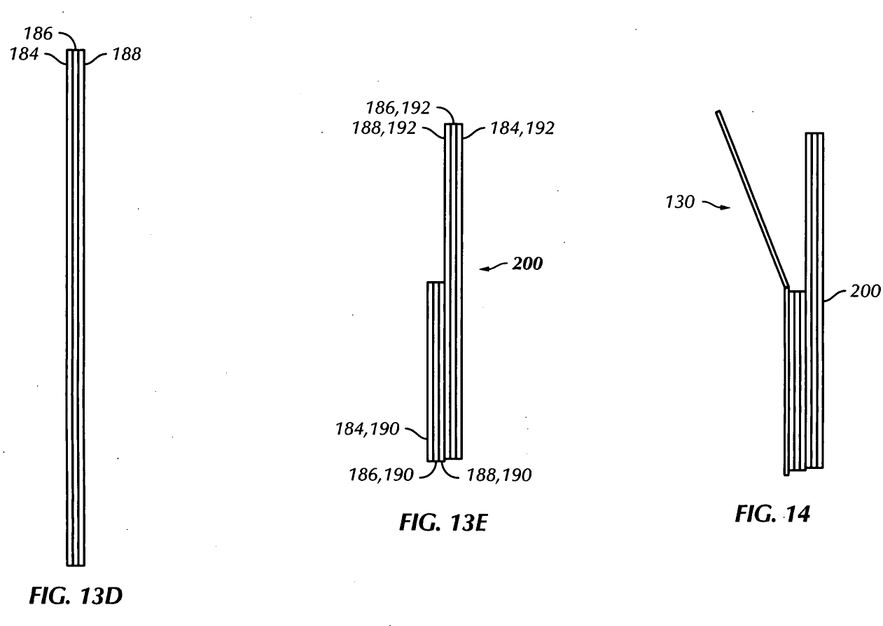

FIGS. 13A, 13B, 13C, 13D and 13E show how the printed circuit antenna configuration 132 can be folded along the dashed lines with sections 184, 186 and 188 overlying each other and with sections 190 and 192 overlying each other to produce a thin antenna configuration 200 that can be held against cell phone 130 to enhance the performance of cell phone 130.

FIG. 14 shows the folded antenna configuration 200 mounted to a cell phone 130 having an internal antenna.

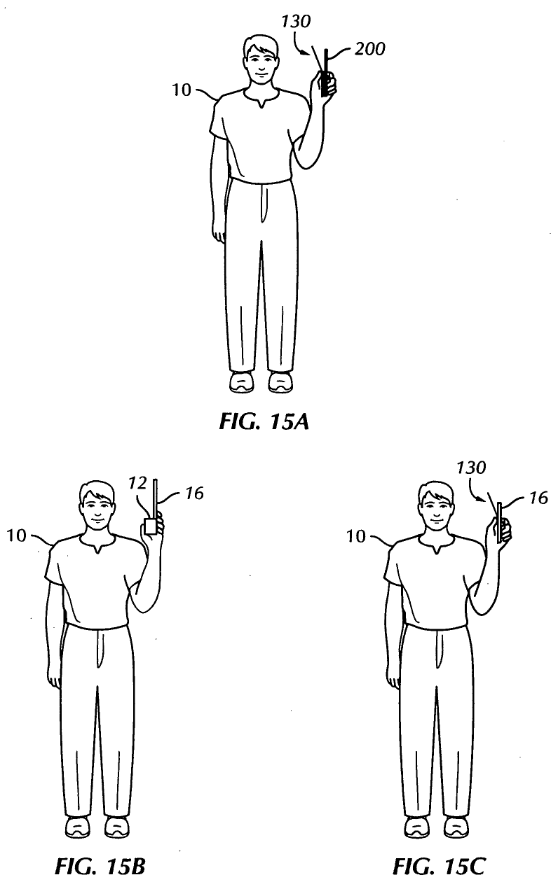

FIGS. 15A-15C illustrates three ways that the present invention may be utilized to improve cell phone performance. FIG. 15A shows a user 10 holding a cell phone 130 which includes the thin folded antenna configuration 200. This is one method, according to the present invention, of improving the performance of a cell phone 130 that incorporates an internal antenna. FIG. 15B shows a user 10 holding a cell phone 12 which includes antenna configuration 16. This is a method, according to the present invention, of improving the performance of a cell phone 12 that incorporates an external antenna 22. FIG. 15C shows a user 10 holding a cell phone 130 which utilizes antenna configuration 16. This is a second method, according to the present invention, of improving the performance of a cell phone that incorporates an internal antenna.

FIGS. 15A, 15B and 15C show several possible ways that an antenna configuration according to the present invention is intended to be utilized. Other ways to use the disclosed antenna configurations in accordance with the present invention will be apparent to those skilled in the art. The stored antenna configuration 41 shown in FIGS. 6A and 6B preferably has the size and shape of a pen so that it can be stored conveniently in a pocket or purse. This antenna configuration can be utilized with cell phones having either external or internal antennas. The antenna configuration 200 preferably has the size and shape of a credit card so that it can also be stored conveniently in a pocket or purse. This antenna configuration can be utilized with cell phones having an internal antenna.

The use of an external antenna configuration according to the present invention is not intended solely for those geographic areas that cannot reliably connect to a cell tower for whatever reason. By utilizing an external antenna configuration according to the present invention in areas with a strong connection to a cell tower, the transmitter within the cell phone may reduce its RF power level making the cell phone less likely to cause health related problems.

In the preferred embodiment of the invention, the following dimensions were selected:

Dimension d1=3.0 inches

Dimension d2=1.5 inches

Dimension d3=3.5 inches

Dimension d4=4.0 inches

Dimension d5=6.0 inches

Dimension d6=0.5 inches

It will be recognized by those skilled in the art that changes may be made to the above described embodiments of the present invention without departing from the broad inventive concepts thereof. For example, the antenna connection to the cell phone may be made via a connector other than the coils which make a wireless connection. In addition, the configuration of the antenna assembly, shown as a generally planar assembly, may be changed to some other configuration while maintaining the portability aspect of the concept. Further, the antenna assembly 14 could be reconfigured and tuned to the frequency of a satellite radio, thus providing the user of such a service enhanced reception. It is understood, therefore, that this invention is not limited to the particular embodiments disclosed, but is intended to cover all modifications to the particular configuration of an external cell phone antenna assembly or the means of connecting the antenna assembly electrically to the cell phone, which are within the scope and spirit of the invention as defined by the appended claims.

I claim:

1. A portable, self contained, dual frequency external antenna configuration for use with a phone, such as a cell phone to enhance cell phone operation, the antenna configuration comprising:
a first antenna tuned to a first cell phone operating frequency;
a second antenna tuned to a second cell phone operating frequency;
a connector adapted for making a connection to the cell phone; and
at least one transmission line connecting the first and second antennas to the connector.

2. The antenna configuration of claim 1 wherein the connector is a wireless connector.

3. The antenna configuration of claim 2 wherein the wireless connector comprises multiple loops sized and shaped to couple to at least a portion of the cell phone antenna.

4. The antenna configuration of claim 1 wherein the first antenna is tuned to a frequency in the range of about 806 to 894 MHz and the second antenna is tuned to a frequency in the range of about 1850 to 1990 MHz.

5. The antenna configuration of claim 1 wherein the first and second antennas each have an overall dimension which is generally one half of the wavelength of respective mid-band first and second cell phone operating frequencies.

6. The antenna configuration of claim 1 wherein the first and second antennas are fabricated as a printed circuit.

7. The antenna configuration of claim 1, further including a housing for receiving the first and second antennas.

8. The antenna configuration of claim 1 wherein the antenna configuration is connected directly to and is supported by a cell phone.

9. A portable, self contained, external antenna configuration for use with a phone, such as a cell phone to enhance cell phone operation, the antenna configuration comprising:
at least a first antenna tuned to a cell phone operating frequency;
a connector adapted for making a connection to the cell phone; and
at least one transmission line connecting the first antenna to the connector.

10. The antenna configuration of claim 9 wherein the connector comprises multiple loops sized and shaped to couple to at least a portion of the cell phone antenna.

11. The antenna configuration of claim 9 further comprising a second antenna tuned to another cell phone operating frequency, the at least one transmission line also connecting the second antenna to the connector.

12. The antenna configuration of claim 9 wherein the first antenna is tuned to one of a frequency in the range of about 806 to 894 MHz and a frequency in the range of about 1850 to 1990 MHz.

13. The antenna configuration of claim 11 wherein the first and second antennas are fabricated as a printed circuit.

14. The antenna configuration of claim 13, further including a container for housing the first and second antennas.

15. The antenna configuration of claim 11 wherein the first antenna is tuned to a frequency in the range of about 806 to 894 MHz and the second antenna is tuned to a frequency in the range of about 1850 to 1990 MHz.

16. The antenna configuration of claim 15 wherein the first and second antennas are fabricated as a printed circuit.

17. The antenna configuration of claim 16, further including a container for housing the first and second antennas.
